(19) United States
(12) Patent Application Publication
(10) Pub. No.: US 2020/0013375 A1
(43) Pub. Date: Jan. 9, 2020

(54) INFORMATION PROCESSING APPARATUS AND INFORMATION PROCESSING METHOD

(71) Applicant: SONY CORPORATION, TOKYO (JP)

(72) Inventors: KOJI NISHIDA, TOKYO (JP); KENICHIRO HOSOKAWA, KANAGAWA (JP); KEISUKE CHIDA, SAITAMA (JP); TAKURO KAWAI, TOKYO (JP)

(21) Appl. No.: 16/482,483

(22) PCT Filed: Jan. 23, 2018
(86) PCT No.: PCT/JP2018/001926

§ 371 Date: Jul. 31, 2019

(30) Foreign Application Priority Data
Mar. 7, 2017 (JP) 2017-042830

(51) Int. Cl. G09G 5/377; G06T 5/50; G06K 9/46; G06T 5/00; G09G 5/02

(52) U.S. Cl. CPC G09G 5/377; G06T 5/50; G09G 5/02; G06T 5/002; G06K 9/4604

(57) ABSTRACT

[Subject] To provide an information processing apparatus and an information processing method. [Solving Means] An information processing apparatus includes a feature quantity identification section and a display control section. The feature quantity identification section identifies, on the basis of an input image prior to image processing and an output image that has undergone the image processing, a feature quantity indicating a change made to an image by the image processing. The display control section causes an indicator regarding an effect of the image processing to be displayed on the basis of the feature quantity.

### TECHNICAL FIELD

The present disclosure relates to an information processing apparatus and an information processing method.

### BACKGROUND ART

Recent years have seen the development of a variety of image processing technologies, with a display apparatus displaying an image (including a still image and a video) after subjecting the image to a variety of image processing tasks. For example, a television receiver (hereinafter may be referred to as a TV) having an image processing function called super-resolution processing causes a high-resolution image acquired by subjecting an image acquired through its reception to the super-resolution processing to be displayed. The super-resolution processing provides a high-resolution image by using a low-resolution image.

On the other hand, PTL 1 listed below describes a technology that generates, from an input image, a super-resolution effect image offering an effect acquired in the case of application of super-resolution processing and causes the super-resolution effect image to be output for display. For example, a user can decide whether super-resolution processing is required by confirming a super-resolution effect image.

### CITATION LIST

### Patent Literature

[PTL 1]

Japanese Patent Laid-Open No. 2010-161760

### SUMMARY

### Technical Problem

However, although capable of predicting and displaying an image processing effect before performing image processing, the above technology has been unable to display any information regarding an effect of the image processing that has actually been performed on the image currently being displayed.

In light of the foregoing, the present disclosure proposes a novel and improved image processing apparatus and image processing method capable of realizing display of information regarding an effect of image processing actually performed.

### Solution to Problem

According to the present disclosure, there is provided an information processing apparatus including: a feature quantity identification section identifying, on the basis of an input image prior to image processing and an output image that has undergone the image processing, a feature quantity indicating a change made to an image by the image processing; and a display control section causing an indicator regarding an effect of the image processing to be displayed on the basis of the feature quantity.

Also, according to the present disclosure, there is provided an information processing method including: identifying, on the basis of an input image prior to image processing and an output image that has undergone the image processing, a feature quantity indicating a change made to an image by the image processing; and causing an indicator regarding an effect of the image processing to be displayed on the basis of the feature quantity.

### Advantageous Effect of Invention

According to the present disclosure described above, it is possible to realize display of information regarding an effect of image processing actually performed.

It should be noted that the effect described above is not necessarily restrictive and that any of the effects given in the present specification or other effect that can be grasped from the present specification may be achieved together with or in place of the above effect.

### BRIEF DESCRIPTION OF DRAWINGS

FIG. 1 is an explanatory diagram for describing an overview of a first embodiment of the present disclosure.

FIG. 2 is a block diagram illustrating a functional configuration example of an information processing apparatus according to the embodiment.

FIG. 3 is a diagram illustrating pixels in a tap size set around a certain pixel.

FIG. 4 is an explanatory diagram illustrating an example of a gain curve used by an effect level identification section according to the same embodiment.

FIG. 5 is an explanatory diagram for describing an example of an indicator according to the same embodiment.

FIG. 6 is an explanatory diagram for describing an example of an indicator according to the same embodiment.

FIG. 7 is an explanatory diagram for describing an example of an indicator according to the same embodiment.

FIG. 8 is an explanatory diagram for describing an example of an indicator according to the same embodiment.

FIG. 9 is a flowchart illustrating an example of operation according to the same embodiment.

FIG. 10 is an explanatory diagram for describing a modification example according to the same embodiment.

FIG. 11 is a block diagram illustrating a configuration example of an information processing apparatus according to a second embodiment of the present disclosure.

FIG. 12 is an explanatory diagram for describing an example of an indicator according to the same embodiment.

FIG. 13 is an explanatory diagram for describing an example of an indicator according to the same embodiment.

FIG. 14 is an explanatory diagram for describing an example of an indicator according to the same embodiment.

FIG. 15 is an explanatory diagram for describing an example of an indicator according to the same embodiment.

FIG. 16 is an explanatory diagram for describing an example of an indicator according to the same embodiment.

FIG. 17 is an explanatory diagram for describing an example of an indicator according to the same embodiment.

FIG. 18 is an explanatory diagram for describing an example of an indicator according to the same embodiment.

FIG. 19 is a flowchart illustrating an example of operation according to the same embodiment.

FIG. 20 is an explanatory diagram illustrating a hardware configuration example.

### DESCRIPTION OF EMBODIMENTS

A detailed description will be given below of preferred embodiments of the present disclosure with reference to attached drawings. It should be noted that components having substantially the same functional configuration in the present specification and the drawings will be denoted by the same reference sign to omit redundant description.

Also, there are cases in which a plurality of components having substantially the same functional configuration is distinguished by attaching different alphabets after the same reference sign in the present specification and the drawings. It should be noted, however, that in the case where there is no need to distinguish between the plurality of components having substantially the same functional configuration, the components will be denoted only by the same reference sign.

It should be noted that the description will be given in the following order:

### <<1. First Embodiment>>

### <1-1. Overview>

### <1-2. Configuration>

### <1-3. Operation>

### <1-4. Modification Example>

### <1-5. Effect>

### <<2. Second Embodiment>>

### <2-1. Configuration>

### <2-2. Operation>

### <2-3. Effect>

### <<3. Hardware Configuration Example>>

### <<4. Conclusion>>

### 1. FIRST EMBODIMENT

### 1-1. Overview

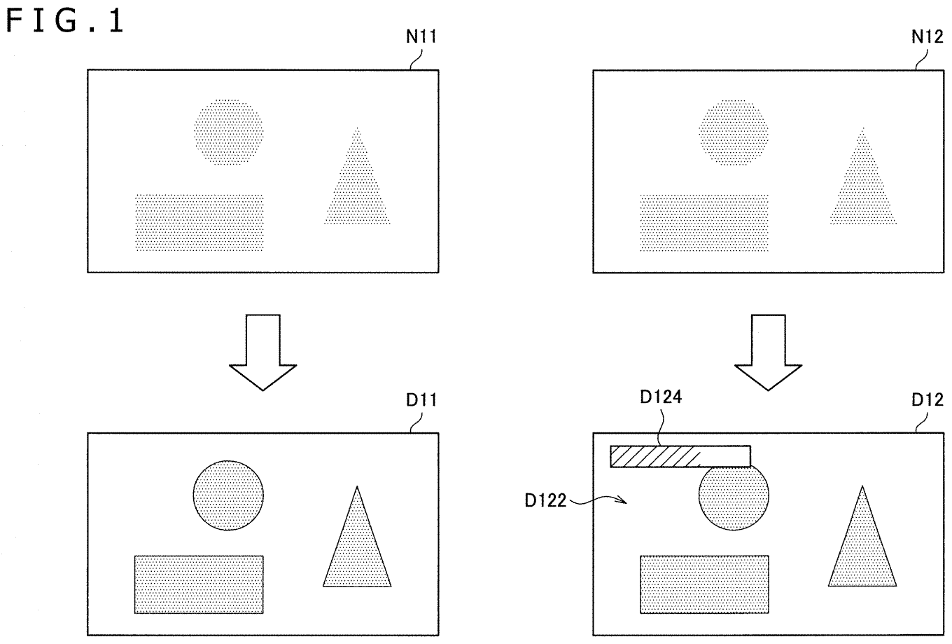

A description will be given first of an overview of a first embodiment of the present disclosure with reference to FIG. 1. FIG. 1 is an explanatory diagram for describing an overview of the first embodiment of the present disclosure.

It is becoming more common in recent years that TVs and other display apparatuses are equipped with an information processing function that displays an input image (including a still image and a video) after performing, on the image, a variety of image processing tasks such as super-resolution processing, noise reduction (NR) process, and contrast conversion process. An image processing apparatus according to the present embodiment may be, for example, a display apparatus having an image processing function as described above.

The images illustrated at the top in FIG. 1 are input images supplied to a display apparatus, and the images illustrated at the bottom in FIG. 1 are display images being displayed (used for display) on the display apparatus.

An example is depicted on the left in FIG. 1 in which an output image (output image acquired after the image processing) resulting from performing image processing (e.g., super-resolution processing) on a supplied input image N11 is displayed as a display image D11. In such an example, the output image that has undergone the image processing matches the display image D11.

Here, only the output image that has undergone the image processing is presented to a user. This makes it difficult for the user to grasp an effect of the image processing performed. For this reason, in the present embodiment, an indicator regarding an effect of the image processing is displayed.

As an example of display by the present embodiment, an example is depicted on the right in FIG. 1 in which the display image D11 appears that is acquired by superimposing an indicator D124 on an output image D122 that has been acquired by performing image processing on a supplied input image N12 (image same as the input image N11).

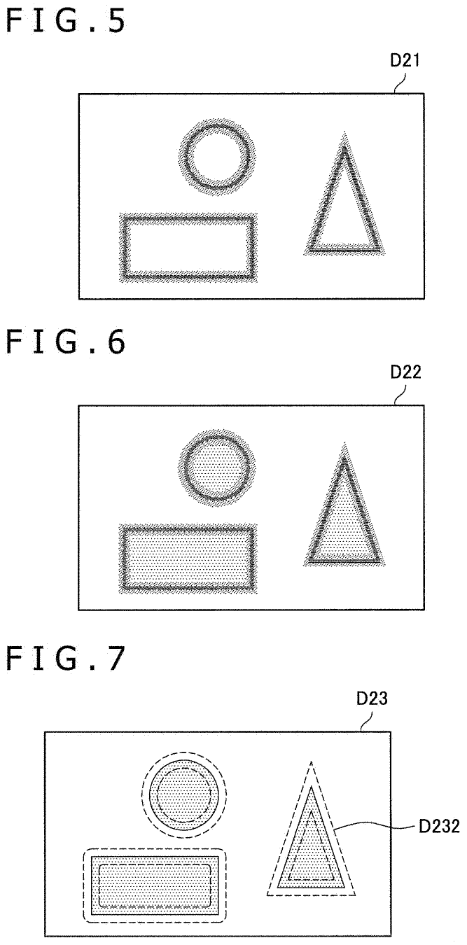

It should be noted that although the indicator D124 illustrated in FIG. 1 is an indicator that indicates an effect of image processing for the entire image, the indicator according to the present embodiment is not limited to the example illustrated in FIG. 1. A description will be given later of other examples of indicators with reference to FIGS. 5 to 8 and so on.

The overview of the first embodiment of the present disclosure has been described above. According to the present embodiment, it is possible for the user to grasp the effect of image processing actually performed by causing an indicator regarding the image processing effect to be displayed as described above. A description will be given next of a configuration example of the first embodiment of the present disclosure for realizing the above effect.

### 1-2. Configuration

### (Overall Configuration)

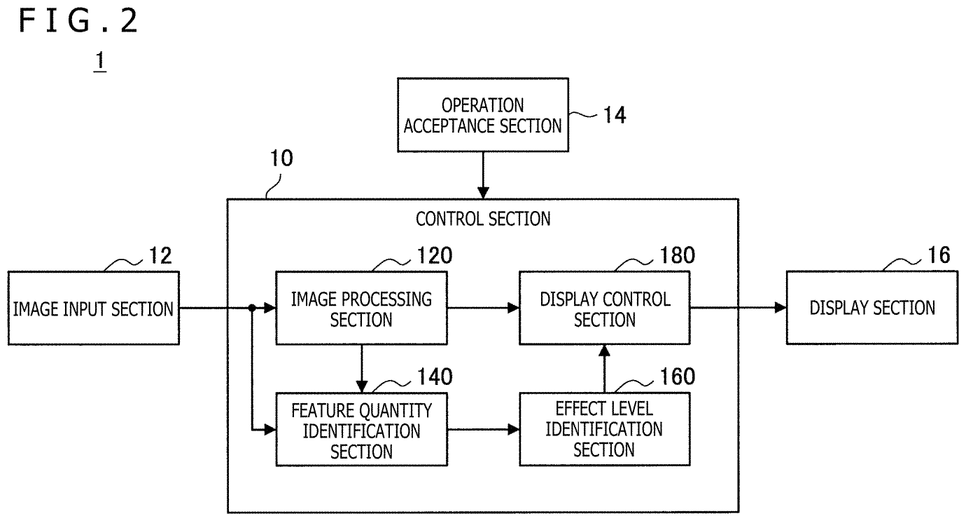

FIG. 2 is a block diagram illustrating a functional configuration example of an information processing apparatus according to the present embodiment. As illustrated in FIG. 2, an information processing apparatus 1 according to the present embodiment includes a control section 10, an image input section 12, an operation acceptance section 14, and a display section 16. In the description given below, the overall configuration of the information processing apparatus 1 will be described first, followed by the description of detailed functions of the control section 10.

It should be noted that the information processing apparatus 1 according to the present embodiment may be, for example, a TV, and a description will be given mainly of an example in which the same device (information processing apparatus 1) offers the functions of the control section 10, the image input section 12, the operation acceptance section 14, and the display section 16. However, the information processing apparatus 1 is not limited to a TV, and the positions where these blocks are located are not specifically limited, either. For example, the display section 16 may be a display apparatus provided separately from the information processing apparatus 1. Also, some of these blocks may be provided in an external server or other location.

The control section 10 controls the respective components of the information processing apparatus 1. Also, the control section 10 according to the present embodiment also functions as an image processing section 120, a feature quantity identification section 140, an effect level identification section 160, and a display control section 180 as illustrated in FIG. 2. Then, the control section 10 receives an image from the image input section 12 which will be described later and outputs a display image to the display section 16 which will be described later. It should be noted that the functions of the control section 10 as the image processing section 120, the feature quantity identification section 140, the effect level identification section 160, and the display control section 180 will be described later.

The image input section 12 inputs an image to the control section 10. The image input section 12 may be realized, for example, in such a manner as to include a communication function for engaging in communication with external apparatuses, and an image received from an external apparatus may be input to the control section 10. Also, the image input section 12 may input, to the control section 10, an image stored in a storage section which is not illustrated and acquired from the storage section. It should be noted that the image input to the control section 10 by the image input section 12 is not limited to a still image and may be a video.

The operation acceptance section 14 accepts user operation. The operation acceptance section 14 may be realized, for example, by physical operating devices such as a button, a keyboard, a mouse, and a touch panel. Also, the operation acceptance section 14 may be realized to include a function for receiving a signal from a remote controller so as to accept user operation made via the remote controller.

For example, the operation acceptance section 14 may accept operation for switching ON or OFF the image processing function by the image processing section 120 of the control section 10 which will be described later. Also, the operation acceptance section 14 may accept operation for setting (adjusting) parameters related to image processing performed by the image processing section 120 of the control section 10 which will be described later. Also, the operation acceptance section 14 may accept operation for switching ON or OFF the display of an indicator related to an effect of image processing.

The display section 16 displays, for example, a display image output from the control section 10 under control of the control section 10.

### (Control Section)

The overall configuration of the information processing apparatus 1 according to the present embodiment has been described above. Next, a detailed description will be given below of the functions of the control section 10 as the image processing section 120, the feature quantity identification section 140, the effect level identification section 160, and the display control section 180 one by one.

The image processing section 120 treats an image input from the image input section 12 as an input image and applies image processing to the input image. Also, the image processing section 120 provides, to the feature quantity identification section 140 and the display control section 180, an output image acquired by performing the image processing on the input image (output image resulting from the image processing).

The image processing performed on the input image by the image processing section 120 is not specifically limited and may be, for example, super-resolution processing, noise reduction (NR) process, contrast conversion process, HDR (High Dynamic Range) conversion process, color conversion process, and so on.

It should be noted that the image processing section 120 may perform image processing appropriate to user operation made via the operation acceptance section 14. For example, image processing may be set to ON or OFF (whether to perform image processing) appropriately to user operation made via the operation acceptance section 14. In the case where image processing is set to OFF, the input image is provided as-is to the display control section 180 without the image processing section 120 performing any image processing. Such a configuration allows the user to set whether to perform image processing while confirming the image processing effect.

Also, the image processing section 120 may perform image processing on the basis of the parameters (e.g., image processing intensity) set by user operation via the operation acceptance section 14 (appropriately to user operation). Such a configuration allows the user to set image processing parameters while confirming the image processing effect.

The feature quantity identification section 140 identifies a feature quantity indicating a change in the image made by the image processing performed by the image processing section 120. The feature quantity identification section 140 may identify a feature quantity, for example, on the basis of the input image prior to the application of the image processing by the image processing section 120 (image input from the image input section 12) and the output image after the image processing.

The feature quantity identified by the feature quantity identification section 140 may be, for example, a feature quantity appropriate to the image processing performed by the image processing section 120. A description will be given below of several examples of feature quantities and feature quantity identification methods. It should be noted that the feature quantities described below may be identified for each pixel included in the image.

For example, in the case where the image processing performed by the image processing section 120 is super-resolution processing, the feature quantity identification section 140 may identify, as a feature quantity, a difference in brightness value between the input image and the output image. It should be noted that such a feature quantity is an index that indicates the extent to which the brightness value has changed between the input image and the output image as a result of the super-resolution processing.

Also, in the case where the image processing performed by the image processing section 120 is super-resolution processing, the feature quantity identification section 140 may identify, as a feature quantity, an increase in dynamic range between the input image and the output image. It should be noted that the dynamic range in each pixel may be, for example, a difference between a maximum value and a minimum value of the pixels in the tap size set around each pixel.

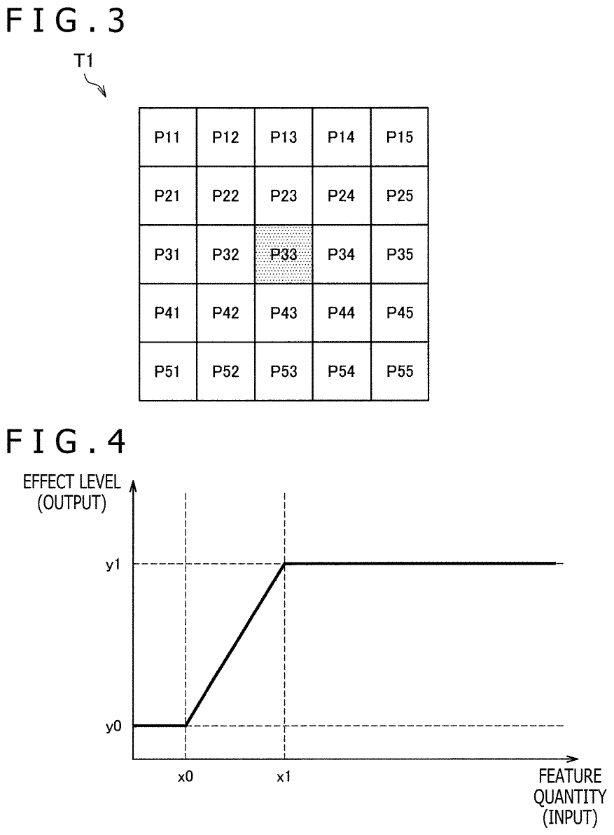

FIG. 3 is a diagram illustrating pixels in a tap size set around a certain pixel. In the example illustrated in FIG. 3, a tap T1 having a 5-by-5 pixel tap size is set around a hatched pixel P33. The dynamic range in the pixel P33 illustrated in FIG. 3 is acquired by subtracting the minimum value from the maximum value of all the pixels (P11 to P55) in the tap T1.

The feature quantity identification section 140 calculates a pixel-by-pixel feature quantity for the input image and the output image each as described above. Further, the feature quantity identification section 140 can acquire, as a feature quantity, an increase in dynamic range in each pixel by subtracting the dynamic range of the input image from the dynamic range of the output image for each pixel. It should be noted that such a feature quantity is an index that indicates the extent to which sharpness has increased in each pixel as a result of super-resolution processing.

Also, in the case where the image processing performed by the image processing section 120 is super-resolution processing, the feature quantity identification section 140 may identify, as a feature quantity, an increase in sum of absolute differences between adjacent pixels (band feature quantity) between the input image and the output image. It should be noted that the sum of the absolute differences between the adjacent pixels for each pixel is, for example, a further summation of absolute values of differences between horizontally adjacent pixels and absolute values of differences between vertically adjacent pixels for the pixels in the tap size set around each pixel.

For example, in the example illustrated in FIG. 3, a difference between horizontally adjacent pixels refers to a difference in pixel value between horizontally adjacent pixels such as the difference between a pixel P11 and a pixel P12 and the difference between the pixel P12 and a pixel P13. For example, in the case where the tap size is 5 pixels by 5 pixels as illustrated in FIG. 3, a total of 20 differences between horizontally adjacent pixels, four in each row, are calculated. Also, for example, in the example illustrated in FIG. 3, a difference between vertically adjacent pixels refers to a difference in pixel value between vertically adjacent pixels such as the difference between the pixel P11 and a pixel P21 and the difference between the pixel 21 and a pixel P31. For example, in the case where the tap size is 5 pixels by 5 pixels as illustrated in FIG. 3, a total of 20 differences between vertically adjacent pixels, four in each column, are calculated. The sum of the absolute differences between the adjacent pixels for the pixel P33 can be acquired by summing up the absolute values of the differences between the horizontally adjacent pixels and the absolute values of the differences between the vertically adjacent pixels acquired as described above.

The feature quantity identification section 140 calculates the sum of the absolute differences between the adjacent pixels for each pixel in the input image and the output image each as described above. Further, the feature quantity identification section 140 can acquire, as a feature quantity, the increase in the sum of the absolute differences between the adjacent pixels for each pixel by subtracting the sum of the absolute differences between the adjacent pixels of the input image from the sum of the absolute differences between the adjacent pixels of the output image for each pixel. It should be noted that such a feature quantity is another index that indicates the extent to which the sharpness has increased in each pixel as a result of the super-resolution processing.

Also, in the case where the image processing performed by the image processing section 120 is an NR process, the feature quantity identification section 140 may identify, as a feature quantity, a difference in brightness value between the input image and the output image. It should be noted that such a feature quantity is an index that indicates the extent to which the brightness value has changed between the input image and the output image as a result of the NR process and indicates a magnitude of noise component.

Also, in the case where the image processing performed by the image processing section 120 is an NR process, the feature quantity identification section 140 may identify, as a feature quantity, a decrement in dynamic range between the input image and the output image. The feature quantity identification section 140 calculates the dynamic range for each pixel of the input image and the output image as described above. Further, the feature quantity identification section 140 can acquire, as a feature quantity, the decrement in dynamic range for each pixel by subtracting the dynamic range of the output image from the dynamic range of the input image for each pixel. It should be noted that such a feature quantity is an index that indicates the extent to which flattening has been achieved in each pixel as a result of the NR process.

Also, in the case where the image processing performed by the image processing section 120 is an NR process, the feature quantity identification section 140 may identify, as a feature quantity, a decrement in the sum of absolute differences between adjacent pixels (band feature quantity) between the input image and the output image. The feature quantity identification section 140 calculates the sum of the absolute differences between the adjacent pixels for each pixel in the input image and the output image each as described above. Further, the feature quantity identification section 140 can acquire, as a feature quantity, the decrement in the sum of the absolute differences between the adjacent pixels for each pixel by subtracting the sum of the absolute differences between the adjacent pixels of the output image for each pixel from the sum of the absolute differences between the adjacent pixels of the input image. It should be noted that such a feature quantity is another index that indicates the extent to which flattening has been achieved in each pixel as a result of the NR process.

Also, in the case where the image processing performed by the image processing section 120 is a contrast conversion process or an HDR conversion process, the feature quantity identification section 140 may identify, as a feature quantity, a difference in brightness value between the input image and the output image. It should be noted that such a feature quantity is an index that indicates the extent to which the brightness value has changed between the input image and the output image as a result of the contrast conversion process or the HDR conversion process.

Also, in the case where the image processing performed by the image processing section 120 is a color conversion process, the feature quantity identification section 140 may identify, as a feature quantity, a difference in color component between the input image and the output image. It should be noted that such a feature quantity is an index that indicates the extent to which the color component has changed between the input image and the output image as a result of the color conversion process.

A description has been given above of the feature quantities identified by the feature quantity identification section 140 and the feature quantity identification methods. It should be noted that the feature quantities identified by the feature quantity identification section 140 and the identification methods thereof are not limited to the examples given above, and, according to the image processing performed by the image processing section 120, an index suitable for indicating the change produced by the image processing in question may be used as a feature quantity. The feature quantity identification section 140 supplies the feature quantity acquired as described above to the effect level identification section 160 illustrated in FIG. 2.

The effect level identification section 160 identifies an effect level indicating the effect of the image processing performed by the image processing section 120 on the basis of the feature quantity provided from the feature quantity identification section 140.

For example, the effect level identification section 160 may identify the effect level for each pixel on the basis of the pixel-by-pixel feature quantity provided from the feature quantity identification section 140. Although the method for identifying the effect level for each pixel is not specifically limited, the effect level identification section 160 may identify the effect level for each pixel on the basis of one of the feature quantities described above, for example, in accordance with a preset gain curve. FIG. 4 is an explanatory diagram illustrating an example of a gain curve.

The gain curve illustrated in FIG. 4 is an example of a gain curve having the feature quantity as an input and the effect level as an output. In the gain curve illustrated in FIG. 4, in the case where the feature quantity is equal to or less than x0, the effect level is constant at y0. In the case where the feature quantity lies between x0 and x1, the effect level increases monotonically with the feature quantity as a parameter. In the case where the feature quantity is equal to or larger than x1, the effect level is constant at y1. It should be noted that the gain curve may be set in advance appropriately to the feature quantity type used for identifying the effect level.

It should be noted that the effect level identification section 160 may identify the effect level on the basis of a plurality of types of feature quantities. For example, the effect level identification section 160 may identify the effect level by summing up or averaging output values acquired in accordance with the gain curve for each feature quantity. It should be noted that a computation process on the output values acquired in accordance with the gain curve for each feature quantity is not limited to summation or averaging and may include, for example, multiplication, calculation process of maximum, minimum, and other values.

Also, the effect level identification section 160 may identify a single effect level for the entire image (effect level of the entire image) by performing a spatial statistical process on the entire image on the basis of the effect level identified for each pixel. It should be noted that the term “statistical process” in the present specification refers, for example, to a process of calculating a statistic of a total, mean, median, or other value. It should be noted that in the case where a statistical process is performed in the description given below, a calculated statistic is not specifically limited. For example, the effect level of the entire image identified by the effect level identification section 160 may be the total, mean, or median of the effect levels identified for the respective pixels, or the like.

Also, in the case where the image input to the control section 10 from the image input section 12 is a video, the effect level identification section 160 may chronologically perform a statistical process between frames on the basis of the effect level. For example, the effect level identification section 160 may perform a statistical process on the frame in question and a plurality of past frames on the basis of the effect level identified by the above method, thus identifying, once again, the effect level regarding the frame in question. It should be noted that the statistic calculated by the chronological statistical process is not specifically limited as in the example of the spatial statistical process described above.

Also, the effect level identification section 160 may perform a statistical process by assigning a weight appropriate to the image processing performed by the image processing section 120. For example, in the case where the image processing performed by the image processing section 120 is super-resolution processing, the effect level identification section 160 may perform a statistical process by assigning a weight appropriate to the magnitude of the dynamic range for each pixel (e.g., the larger the dynamic range, the larger the weight assigned). Such a weight assignment allows for a statistical process that attaches importance to a texture region where the super-resolution processing is likely to be significantly effective rather than a flat region where the super-resolution processing is likely to be insignificantly effective. Also, in the case where the image processing performed by the image processing section 120 is an NR process, the effect level identification section 160 may perform a statistical process such that the smaller the dynamic range for each pixel, the larger the weight assigned. Such a weight assignment allows for a statistical process that attaches importance to a flat region where it is easy to decide a noise amount rather than a texture region where it is difficult to distinguish between noise and texture.

Also, the parameters (e.g., parameters related to a gain curve shape, a statistic type, and weight assignment) used in the case of identification of the effect level for each pixel through the gain curve descried above or in the case of a statistical process performed on the effect level are not fixed and may be varied physically in accordance with various conditions. For example, the above parameter may be a parameter appropriate to a display mode (e.g., cinema mode, sports mode, dynamic mode) of the information processing apparatus 1. Also, the above parameter may be a parameter appropriate to a user preference acquired from image quality or other setting specified by the user. Also, the above parameter may be a parameter appropriate to illuminance, acquired from an illuminance sensor which is not illustrated, or viewing environment element acquired from a user's viewing distance, screen size setting, and so on.

The effect level identification section 160 provides the effect level for each pixel or for the entire image acquired as described above to the display control section 180 illustrated in FIG. 2.

The display control section 180 controls the display of the display section 16 by generating a display image to be displayed on the display section 16 and providing the image to the display section 16. For example, the display control section 180 may cause an indicator regarding the image processing effect performed by the image processing section 120 to be displayed on the basis of the effect level identified by the effect level identification section 160 as described above on the basis of the feature quantity. It should be noted that the display control section 180 may also cause an interface (e.g., a button or an adjustment bar) for user operation accepted via the operation acceptance section 14 to be displayed. Also, the display control section 180 may switch ON or OFF the indicator display or change the indicator type appropriate to the user operation.

The indicator caused to be displayed by the display control section 180 may be a one-dimensional indicator indicating the image processing effect for the entire image such as the indicator D124 in a bar form illustrated in FIG. 1. It should be noted that the indictor D124 illustrated in FIG. 1 indicates a one-dimensional effect level acquired as a result of a spatial statistical process performed on the entire image by the effect level identification section 160. Such a one-dimensional indicator indicating the image processing effect for the entire image as illustrated in FIG. 1 allows the user to readily grasp the image processing effect for the entire image.

It should be noted that in the case where a one-dimensional indicator (e.g., indicator in a bar form) is displayed, the display control section 180 may set the maximum value of the indicator in question appropriate to the input image. For example, in the case where the image processing is super-resolution processing, the likelihood for the image processing to be effective varies depending on the input image resolution. Therefore, a maximum value table appropriate to the input image resolution may be prepared in advance and the maximum value may be set in accordance with the table. It should be noted that the method for setting the maximum value of the indicator is not limited to that described above using a resolution, and the maximum value of the indicator may be set appropriately to a variety of parameters. For example, the maximum value of the indicator may be set appropriately to the input image quality. It should be noted that the input image quality can be identified, for example, from a bitrate for video delivery or information regarding an input source of the input image (e.g., information such as terrestrial broadcasting, satellite broadcasting, DVD, Blu-ray (registered trademark) Disc, and so on).

Also, the indicator displayed on the display section 16 by the display control section 180 is not limited to the example illustrated in FIG. 1. A description will be given below of examples of indicators and display images displayed on the display section 16 by the display control section 180 with reference to FIGS. 5 to 8. FIGS. 5 to 8 are explanatory diagrams for describing other examples of indicators according to the present embodiment. It should be noted that, in the description given below, each indicator indicates the image processing effect performed on the input image N11 illustrated in FIG. 1.

Also, in the case where the effect level identification section 160 identifies an effect level for each pixel and provides the pixel-by-pixel effect level to the display control section 180, the display control section 180 may cause, for each pixel, an indicator to be displayed with a pixel value appropriate to the effect level. It should be noted that the pixel value appropriate to the effect level may be, for example, a pixel value having a brightness value appropriate to the effect level or a pixel value having a hue value appropriate to the effect level.

Such a configuration allows the user to confirm the image processing effect for each pixel, thus making it possible to grasp the image processing effect in a more detailed manner.

For example, in the example illustrated in FIG. 5, a display image D21 including an indicator having a pixel value appropriate to the effect level is displayed on the display section 16. It should be noted that the display image D21 illustrated in FIG. 5 includes only the indicator and does not include an output image or other images. For this reason, the user switches ON or OFF the indicator display to confirm the image processing effect and view the output image that has been subjected to the image processing.

Therefore, the display control section 180 may cause the indicator and the output image to be displayed at the same time for presentation to the user. Such a configuration allows the user to confirm the output image and the indicator at the same time. It should be noted that, in the present disclosure, the simultaneous display of an indicator and an output image does not necessarily mean that all the information of the indicator and the output image is included in the display image, and it is sufficient that at least part of indicator information and part of output image information are included in the display image at the same time.

For example, the display control section 180 may cause the indicator to be superimposed on the output image for display. It should be noted that, in the present disclosure, the superimposition of the indicator on the output image may refer, for example, to overlaying the indicator on the output image in a translucent manner or overlaying the indicator on the output image in a non-transparent manner. For example, in the example already described illustrated in FIG. 1, the display image D11 acquired by superimposing the indicator D124 on the output image D122 in a translucent manner is displayed on the display section 16.

Also, the display control section 180 may cause color information appropriate to the effect level to be displayed as an indicator. For example, the display control section 180 may cause the output image (brightness information) and the indicator (color information) to be displayed at the same time. This is accomplished by replacing color information of the output image with a value acquired by normalizing (e.g., applying a gain or offset to) the effect level in such a manner that the effect level falls within bounds of color information values. Such a configuration allows all brightness information of the output image to be displayed, thus making it possible for the user to grasp the output image as a whole.

Also, the display control section 180 may cause the output image (part of brightness information and color information) and the indicator (part of color information) to be displayed at the same time. This is accomplished by adding together the value, acquired by normalizing the effect level in such a manner that the effect level falls within bounds of color information values, and the value of the color information of the output image. Such a configuration allows to demonstrate the image processing effect by changing color information in the region where the image processing is effective while displaying color information of the output image.

For example, in the example illustrated in FIG. 6, brightness information of a display image D22 is brightness information of the output image (the display image D11 illustrated in FIG. 1), and color information of the display image D22 is color information (an example of an indicator) appropriate to the effect level.

It should be noted that the display control section 180 may further cause a color sample indicating correspondence between the color information and the effect level to be displayed. Such a configuration allows for easy understanding of the magnitude of the effect indicated by the color information.

Also, the display control section 180 may cause an indicator indicating the region where the image processing is significantly effective (the effect level is high) in the output image to be displayed. For example, the display control section 180 may cause a border (an example of an indicator) of the region where the image processing is significantly effective in the output image to be displayed. It should be noted that the brightness, color, thickness, line type (shape), and so on of the border displayed as an indicator are not specifically limited, and various kinds of borders may be used. Such a configuration allows the user to grasp the region where the image processing is significantly effective in the output image with more ease.

It should be noted that the display control section 180 may identify a border surrounding the region where the image processing is significantly effective, for example, by generating a binary image acquired by binarizing the pixel-by-pixel effect level using a given threshold and detecting an edge of the binary image through a known edge detection process.

Also, the display control section 180 may identify a plurality of gradual borders appropriate to effect level heights by using a plurality of thresholds (e.g., 10%, 20%, . . . , 90%) and cause the plurality of borders (an example of an indicator) to be displayed in a similar manner to contours (horizontal curves). Such a configuration allows to grasp a distribution of the image processing effect and the effect level thereof with more ease.

It should be noted that in the case where the plurality of borders are displayed, the display control section 180 may cause the borders to be displayed with different brightnesses, colors, thicknesses, line types (shapes) and so on appropriately to the magnitudes of the corresponding thresholds of the respective borders. Such a configuration provides improved viewability.

For example, a display image D23 illustrated in FIG. 7 includes dotted lines D232 (an example of an indicator) indicating the regions where the image processing is significantly effective in the output image (the display image D11 illustrated in FIG. 1).

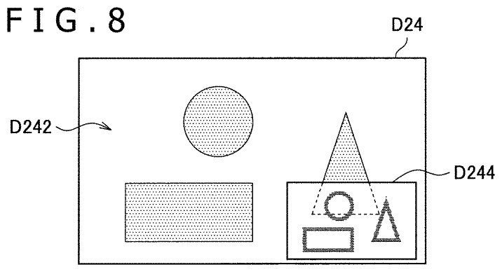

Also, the display control section 180 may cause a child screen with an indicator in a reduced size to be displayed. For example, the display control section 180 may superimpose the child screen on the output image for display. In a display image D24 illustrated in FIG. 8, for example, a child screen D244 with an indicator in a reduced size expressed in pixel value appropriate to the effect level is superimposed on an output image D242. It should be noted that the indicator displayed as a child screen is not limited to such an example, and a child screen with an indicator in a reduced size other than the above may be displayed.

Although a description has been given above of examples of indicators and display images caused to be displayed by the display control section 180 according to the present embodiment, the present technology is not limited to such examples, and a variety of indicators and display images may be displayed.

### 1-3. Operation

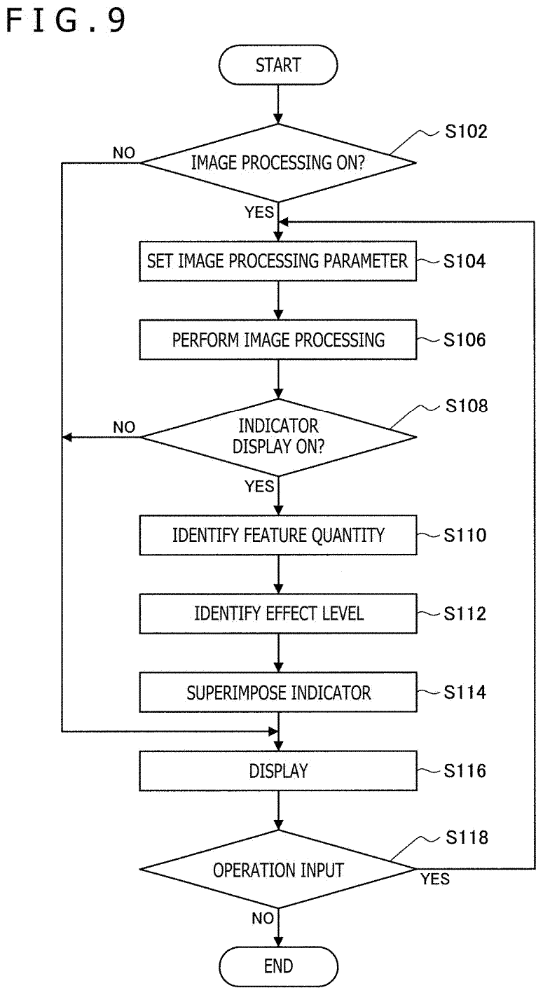

A configuration example according to the present embodiment has been described above. A description will be given next of an example of operation according to the present embodiment with reference to FIG. 9. FIG. 9 is a flowchart illustrating an example of operation according to the present embodiment.

As illustrated in FIG. 9, it is decided first whether the image processing, set appropriately to user operation, is ON or OFF (S102). In the case where the image processing is set to OFF (NO in S102), the input image is provided as-is to the display control section 180 with no image processing performed by the image processing section 120, and the display control section 180 causes the input image to be displayed on the display section 16 (S116).

On the other hand, in the case where the image processing is set to ON (YES in S102), a parameter (e.g., intensity) related to the image processing is set appropriately to user operation (S104). The image processing section 120 applies the image processing to the input image on the basis of the set parameters, thus acquiring an output image that has been subjected to the image processing (S106).

It is decided whether the indicator display, set appropriately to user operation, is ON or OFF (S108). In the case where the indicator display is set to OFF (NO in S108), the display control section 180 causes the output image to be displayed on the display section 16 without causing the indictor to be displayed (S116).

On the other hand, in the case where the indicator display is set to ON (YES in S108), the feature quantity identification section 140 identifies the feature quantity (S110). Next, the effect level identification section 160 identifies the effect level on the basis of the feature quantity (S112). Further, the display control section 180 generates a display image by causing an indicator to be superimposed on the output image on the basis of the effect level (S114) and causes the display image in question to be displayed on the display section 16 (S116).

Next, in the case where a parameter setting related to the image processing is changed, for example, by user operation input (YES in S118), the process returns to step S104, and the image processing and other processes are performed on the basis of a new parameter setting. On the other hand, if there is no user operation input (NO in S118), the process is terminated.

It should be noted that the example illustrated in FIG. 9 is merely an example, and the operation according to the present embodiment can be diverse. For example, in the case where the input image is a video, the series of processes or some of the processes illustrated in FIG. 9 may be repeated.

### 1-4. Modification Example

A description has been given above of a configuration example and operation example according to the present embodiment. A modification example of the present embodiment will be described below. It should be noted that the modification examples described below may be applied alone or in combination with each other to the present embodiment. Also, the present modification example may be performed in place of the configuration described in the present embodiment or in addition to the configuration described in the present embodiment.

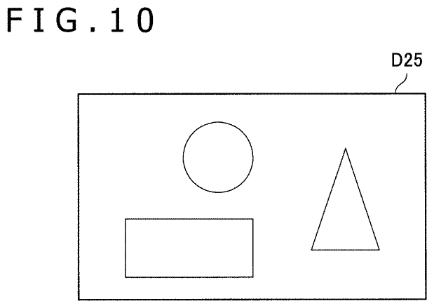

Although an example has been described above in which an indicator is caused to be displayed by the display control section 180 on the basis of the effect level identified by the effect level identification section 160, the present embodiment is not limited to such an example. For example, the display control section 180 may, by directly using a feature quantity identified by the feature quantity identification section 140, cause, for example, an image having a pixel value appropriate to the feature quantity (an example of an indicator) to be displayed. In such a case, the control section 10 need not have the function as the effect level identification section 160. FIG. 10 is an explanatory diagram for describing such a modification example. For example, a display image D25 illustrated in FIG. 10 includes pixels each of which has a pixel value appropriate to the feature quantity.

### 1-5. Effect

A description has been given above of the first embodiment of the present disclosure. According to the present embodiment, it is possible to display an indicator regarding an effect of image processing actually performed. Then, the user can perform operation for switching ON or OFF the image processing and operation for changing parameter settings related to the image processing while confirming the image processing effect.

### 2. SECOND EMBODIMENT

In the above first embodiment, a description has been given in which only one image processing task is performed. Incidentally, in the case where a plurality of image processing tasks is performed, it is extremely difficult to grasp the extent to which each of the image processing tasks is effective by simply looking at an image that has undergone the plurality of image processing tasks in question. For this reason, a description will be given below, as a second embodiment, of an example in which an information processing apparatus causes an image acquired by subjecting an input image to a plurality of image processing tasks to be displayed.

### 2-1. Configuration

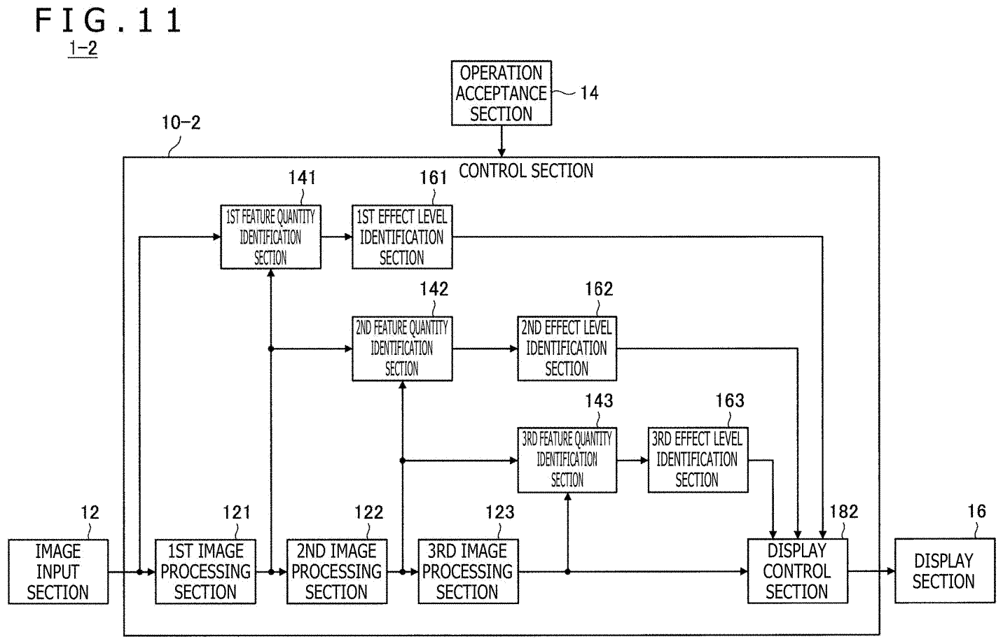

FIG. 11 is a block diagram illustrating a configuration example of an information processing apparatus according to a second embodiment of the present disclosure. As illustrated in FIG. 11, an information processing apparatus 1-2 according to the present embodiment includes a control section 10-2, the image input section 12, the operation acceptance section 14, and the display section 16. Of the components illustrated in FIG. 11, the image input section 12, the operation acceptance section 14, and the display section 16 are configured substantially in the same manner as the image input section 12, the operation acceptance section 14, and the display section 16 described with reference to FIG. 2, respectively. Therefore, the description thereof is omitted here, and the description will be mainly focused on the control section 10-2.

The control section 10-2 controls each component of the information processing apparatus 1-2. Also, the control section 10-2 according to the present embodiment includes, as illustrated in FIG. 11, functions as a first image processing section 121, a second image processing section 122, a third image processing section 123, a first feature quantity identification section 141, a second feature quantity identification section 142, a third feature quantity identification section 143, a first effect level identification section 161, a second effect level identification section 162, a third effect level identification section 163, and a display control section 182.

The first image processing section 121, the second image processing section 122, and the third image processing section 123 perform image processing as does the image processing section 120 described in the first embodiment. It should be noted that the first image processing section 121, the second image processing section 122, and the third image processing section 123 may be collectively referred to as the image processing sections 121 to 123. As for the image processing sections 121 to 123, the description of their similarities to the image processing section 120 will be omitted, and only differences therefrom will be described below.

The first image processing section 121 performs a first image processing task on an image input from the image input section 12 as a first input image, thus acquiring a first output image that has been subjected to the first image processing task. The second image processing section 122 performs a second image processing task on the first output image input from the first image processing section 121 as a second input image, thus acquiring a second output image that has been subjected to the second image processing task. The third image processing section 123 performs a third image processing task on the second output image input from the second image processing section 122 as a third input image, thus acquiring a third output image that has been subjected to the third image processing task. Therefore, the third output image is an output image acquired by subjecting the first input image input from the image input section 12 to all image processing tasks, namely, the first, second, and third image processing tasks.

It should be noted that although not specifically limited, the first image processing task, the second image processing task, and the third image processing task performed by the first image processing section 121, the second image processing section 122, and the third image processing section 123, respectively, may be different image processing tasks.

The first feature quantity identification section 141, the second feature quantity identification section 142, and the third feature quantity identification section 143 identify feature quantities on the basis of the input image and the output image as does the feature quantity identification section 140 described in the first embodiment. It should be noted that the first feature quantity identification section 141, the second feature quantity identification section 142, and the third feature quantity identification section 143 may be collectively referred to as the feature quantity identification sections 141 to 143. The feature quantity identification sections 141 to 143 use a similar feature quantity identification method to that of the feature quantity identification section 140. Therefore, the description of their similarities to the feature quantity identification section 140 will be omitted, and only differences from the image processing section 120 will be described below.

The first feature quantity identification section 141 identifies a first feature quantity regarding the first image processing task on the basis of the first input image and the first output image. Also, the second feature quantity identification section 142 identifies a second feature quantity regarding the second image processing task on the basis of the second input image and the second output image. Also, the third feature quantity identification section 143 identifies a third feature quantity regarding the third image processing task on the basis of the third input image and the third output image.

The first effect level identification section 161, the second effect level identification section 162, and the third effect level identification section 163 identify effect levels on the basis of feature quantities as does the effect level identification section 160 described in the first embodiment. It should be noted that the first effect level identification section 161, the second effect level identification section 162, and the third effect level identification section 163 may be collectively referred to as the effect level identification sections 161 to 163. The effect level identification sections 161 to 163 use a similar effect level identification method to that of the effect level identification section 160. Therefore, the description of their similarities to the effect level identification section 160 will be omitted, and only differences therefrom will be described below.

The first effect level identification section 161 identifies an effect level regarding the first image processing task on the basis of the first feature quantity. Also, the second effect level identification section 162 identifies an effect level regarding the second image processing task on the basis of the second feature quantity. Also, the third effect level identification section 163 identifies an effect level regarding the third image processing task on the basis of the third feature quantity.

The display control section 182 causes an indicator regarding an image processing effect to be displayed as does the display control section 180 described in the first embodiment. It should be noted, however, that the display control section 182 according to the present embodiment differs from the display control section 180 in that an indicator regarding a plurality of image processing effects is displayed. As for the display control section 182, the description of its similarities to the display control section 180 will be omitted, and only differences therefrom will be described below.

The display control section 182 may cause an indicator to be displayed on the basis of the first effect level, the second effect level, and the third effect level identified by the first effect level identification section 161, the second effect level identification section 162, and the third effect level identification section 163 described above.

It should be noted that although, in the example illustrated in FIG. 11, an example is described in which the information processing apparatus 1-2 performs three image processing tasks and identifies a feature quantity and an effect level regarding each image processing task, the present embodiment is not limited to such an example. For example, two image processing tasks or three or more image processing tasks may be performed. In such a case, for example, the information processing apparatus 1-2 may include as many image processing sections, feature quantity identification sections, and effect level identification sections as the number of image processing tasks. Also, as many effect levels regarding the respective image processing tasks as the number of image processing tasks may be identified. The description will be continued below assuming that a plurality of effect levels regarding a plurality of image processing tasks has been identified without limiting the number of image processing tasks to three. It should be noted that, in the description given below, an output image that has undergone all the plurality of image processing tasks to be performed will be referred to as a final output image.

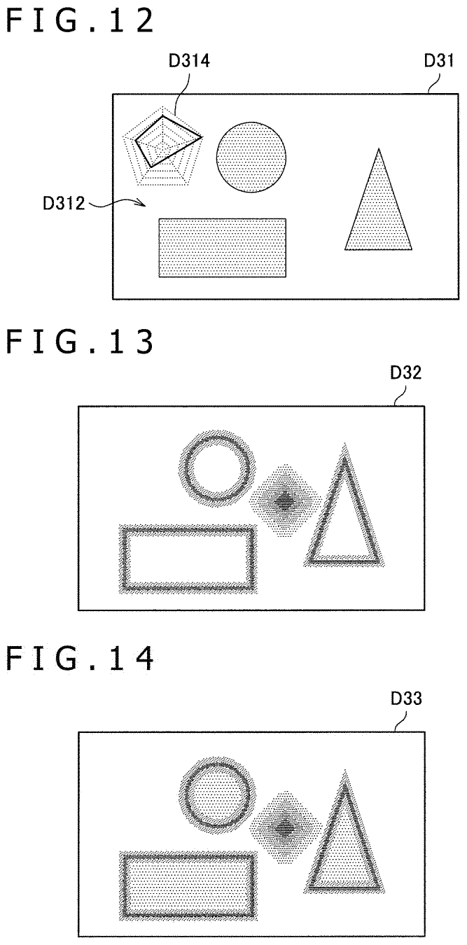

A description will be given below of examples of indicators caused to be displayed by the display control section 182 with reference to FIGS. 12 to 18. FIGS. 12 to 18 are explanatory diagrams for describing examples of indicators according to the present embodiment.

For example, the display control section 182 may cause an indicator in a radar chart form having a plurality of axes corresponding to a plurality of effect levels to be displayed. In a display image D31 illustrated in FIG. 12, an indicator D314 in a radar chart form is superimposed on a final output image D312. It should be noted that each axis of the indicator D314 indicates an effect of a different image processing task on the entire image.

Such a configuration allows the user to readily grasp a plurality of image processing effects.

It should be noted that the display control section 182 may cause an indicator regarding a single image processing effect corresponding to a selected axis to be displayed appropriately to user operation. In such a case, for example, the display control section 182 may cause one of the indicators described with reference to FIGS. 1 and 5 to 8 to be displayed as an indicator regarding a single image processing effect. Such a configuration allows the user to select, of the plurality of image processing tasks, a desired image processing task and confirm the effect thereof.

Also, the display control section 182 may cause an indicator to be displayed with a pixel value corresponding to the effect level regarding each image processing task. In the example illustrated in FIG. 13, a display image D32 is displayed on the display section 16. The display image D32 includes an indicator expressed in pixel value corresponding to the plurality of effect levels. It should be noted that, in such a case, pixel values appropriate to not only effect level values but also effect level types (e.g., the first effect level and the second effect level) may be used. For example, the display control section 182 may cause an indicator to be displayed with a pixel value acquired by assigning the effect level regarding each image processing task to a different color (e.g., RGB value in an RGB color space). Such a configuration allows the user to confirm the plurality of image processing effects for each pixel, thus making it possible to grasp the image processing effects in a more detailed manner.

Also, the display control section 182 may cause an indicator regarding the plurality of image processing effects and the final output image to be displayed at the same time for presentation to the user. Such a configuration allows the user to confirm the output image and the indicator regarding the plurality of image processing effects at the same time.

For example, the display control section 182 may cause color information regarding a plurality of image processing effects to be displayed as an indicator appropriately to effect levels regarding a plurality of image processing tasks. For example, the display control section 182 may assign each of ‘U’ and ‘V,’ which are color information in a YUV color space, to an effect level regarding a different image processing task and replace ‘U’ and ‘V’ in the color information of the output image with the values appropriate to the effect levels in question. Also, the display control section 182 may cause the output image (part of brightness information and color information) and the indicator (part of color information) to be displayed at the same time by adding together ‘U’ and ‘V’ in the color information of the output image and the values appropriate to the effect levels in question. It should be noted that the display control section 182 is not limited to such an example and may cause color information regarding a plurality of image processing effects to be displayed by changing an RGB ratio or a color ratio of a given gradation pattern appropriate to each effect level. For example, ‘U’ and ‘V’ values may be determined by associating the respective image processing tasks with ‘R,’ ‘G,’ and ‘B’ in the RGB color space, determining the corresponding RGB ratios appropriately to the effect levels regarding the respective image processing tasks, and performing a color matrix conversion. For changing the color ratio of a gradation pattern, ‘U’ and ‘V’ values can also be determined in a similar manner. Also, color information may be identified in accordance with a correspondence table prepared in advance that is appropriate to a plurality of effect levels.

For example, in the example illustrated in FIG. 14, brightness information of a display image D33 is brightness information of a final output image, and color information of the display image D33 is color information (an example of an indicator) regarding a plurality of image processing effects appropriate to a plurality of effect levels.

It should be noted that the display control section 182 may further cause a color sample indicating correspondence between effect levels regarding a plurality of image processing tasks and the pixel values or color information described above to be displayed. Such a configuration allows for easy understanding of the magnitude of each image processing effect.

Also, the display control section 182 may cause an indicator indicating a region where each image processing task is significantly effective in the final output image to be displayed. For example, the display control section 182 may cause a border (an example of an indicator) of the region where each image processing task is significantly effective in the final output image to be displayed. Such a configuration allows the user to grasp the region where each image processing task is significantly effective in the final output image with more ease.

It should be noted that the display control section 182 may use different brightnesses, colors, thicknesses, line types (shapes), and so on for the borders displayed as an indicator appropriately to the corresponding image processing tasks. Such a configuration provides improved viewability.

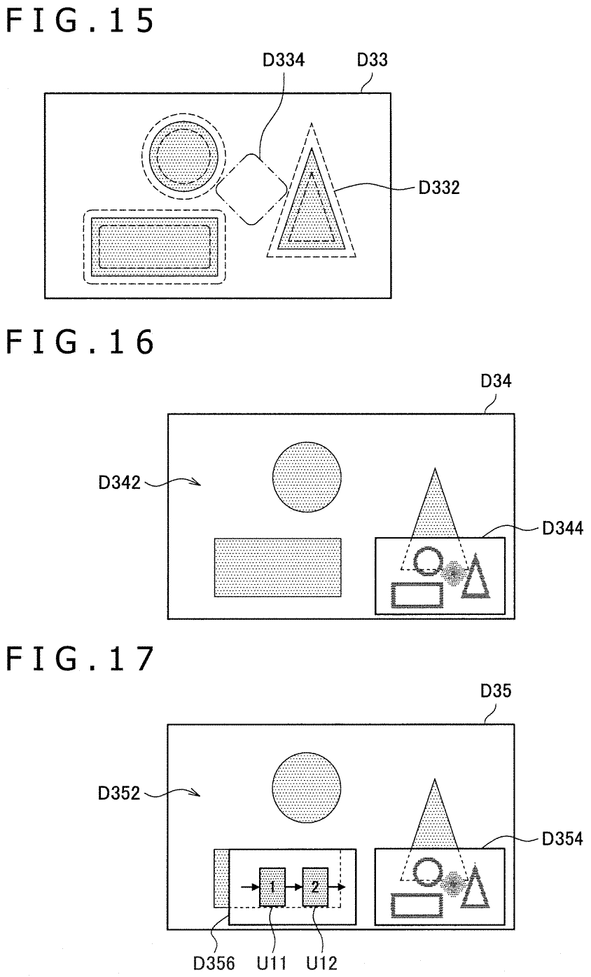

For example, the display image D33 illustrated in FIG. 15 includes, as indicators, a dotted line D332 and a long dashed short dashed line D334 in the final output image. The dotted line D332 indicates a region where certain image processing task is significantly effective. The long dashed short dashed line D334 indicates a region where other image processing task is significantly effective.

Also, the display control section 182 may cause a first child screen with indicators in reduced sizes regarding a plurality of image processing effects to be displayed. For example, the display control section 182 may superimpose the first child screen on the final output image for display. For example, in a display image D34 illustrated in FIG. 16, a first child screen D344 is superimposed on a final output image D342. The first child screen D344 includes indicators in reduced sizes having pixel values appropriate to a plurality of effect levels.

Also, the display control section 182 may further cause a second child screen that depicts a plurality of image processing flows to be displayed. In such a case, the display control section 182 may cause the display of the first child screen to be varied appropriately to user operation made via the operation acceptance section 14. For example, the display control section 182 may cause a first child screen regarding a selected image processing effect to be displayed.

In a display image D35 illustrated in FIG. 17, a first child screen D344 (an example of an indicator) and a second child screen D356 are superimposed on a final output image D352. In the example illustrated in FIG. 17, the second child screen D356 depicts that both an interface U11 corresponding to the first image processing task and an interface U12 corresponding to the second image processing task are selected, and the first child screen D354 is an indicator regarding two image processing effects.

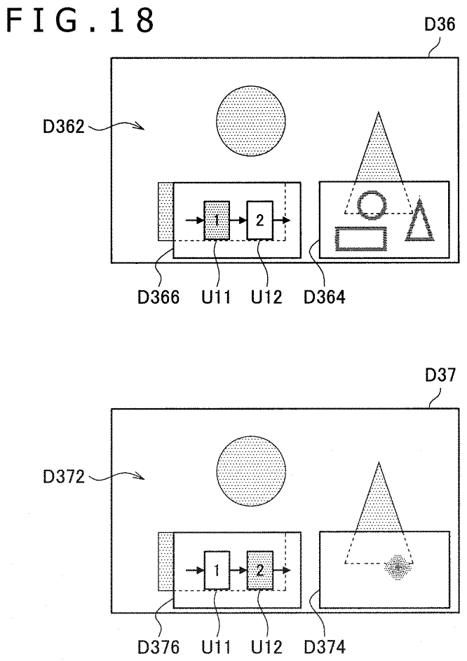

Here, if only the interface U11 corresponding to the first image processing task is selected by user operation (if the selection of the interface U12 corresponding to the second image processing task is cancelled), a display image D36 illustrated in FIG. 18 is, for example, displayed. In the display image D36 illustrated in FIG. 18, a first child screen D364 (an example of an indicator) and a second child screen D366 are superimposed on a final output image D362. The second child screen D366 depicts that only the interface U11 corresponding to the first image processing task is selected, and the first child screen D364 is an indicator regarding the first image processing effect.

On the other hand, if only the interface U11 corresponding to the second image processing task is selected by user operation, a display image D37 illustrated in FIG. 18, for example, is displayed. In the display image D37 illustrated in FIG. 18, a first child screen D374 (an example of an indicator) and a second child screen D376 are superimposed on a final output image D372. The second child screen D376 depicts that only the interface U12 corresponding to the second image processing task is selected, and the first child screen D374 is an indicator regarding the second image processing effect.

It should be noted that the first child screen with the plurality of image processing tasks selected is not limited to the example illustrated in FIG. 17, and any one of the indicators regarding the plurality of image processing tasks described above may be displayed in the first child screen in a reduced size. Also, the first child screen with the plurality of image processing tasks selected may be split further into a plurality of child screens, each including the indicator or indicators in reduced sizes described with reference to FIGS. 1 and 5 to 8. Also, the first child screen with an image processing task selected is not limited to the example illustrated in FIG. 18, and, for example, the first child screen may include, in a reduced size, any one of the indicators described with reference to FIGS. 1 and 5 to 8.

Such a configuration allows the user to select, of the plurality of image processing tasks, a desired image processing task and confirm the effect thereof.

### 2-2. Operation

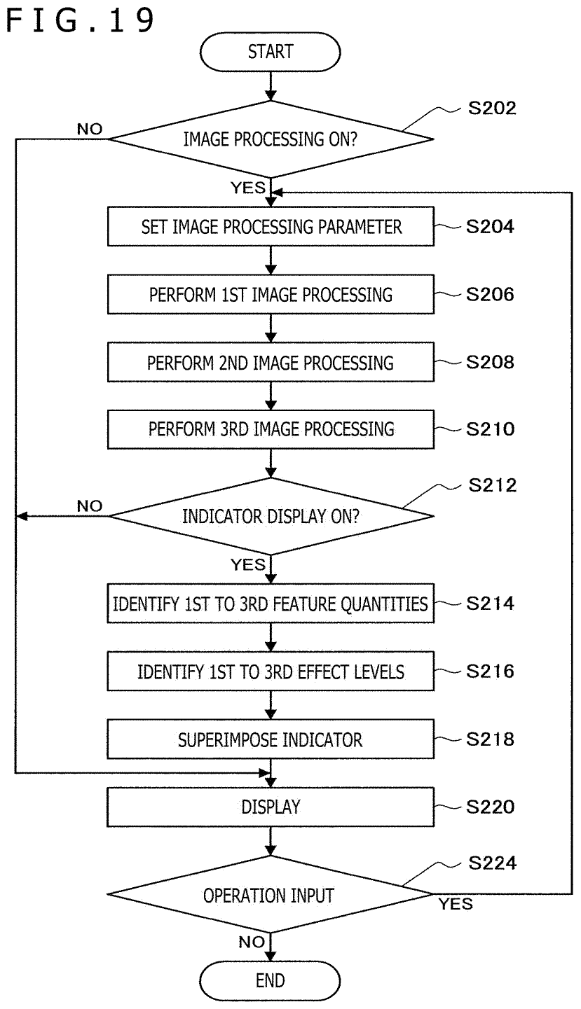

A description has been given above of a configuration example of the present embodiment. A description will be given next of an example of operation according to the present embodiment with reference to FIG. 19. It should be noted that an example will be described in which three image processing tasks are performed as in the example illustrated in FIG. 11. FIG. 19 is a flowchart illustrating an example of operation according to the present embodiment.

As illustrated in FIG. 19, it is decided first whether the image processing, set appropriately to user operation, is ON or OFF (S202). In the case where the image processing is set to OFF (NO in S202), the input image is provided as-is to the display control section 182 with no image processing performed by any of the image processing sections 121 to 123, and the display control section 182 causes the input image to be displayed on the display section 16 (S220).

On the other hand, in the case where the image processing is set to ON (YES in S202), parameters (e.g., intensity) related to each of the image processing tasks are set appropriately to user operation (S204). The image processing sections 121 to 123 perform the first to third image processing tasks, respectively, on the input images input to the image processing sections 121 to 123 on the basis of the set parameters, thus acquiring output images that have been subjected to the image processing (S206, S208, and S210).

Next, it is decided whether the indicator display, set appropriately to user operation, is ON or OFF (S212). In the case where the indicator display is set to OFF (NO in S212), the display control section 182 causes the final output image (third output image output from the third image processing section 123) to be displayed on the display section 16 without causing the indictor to be displayed (S220).

On the other hand, in the case where the indicator display is set to ON (YES in S212), the feature quantity identification sections 141 to 143 identify the first to third feature quantities (S214). Next, the effect level identification sections 161 to 163 identify the effect levels on the basis of the respective feature quantities (S216). Further, the display control section 182 generates a display image by causing indicators to be superimposed on the final output image on the basis of the first to third effect levels (S218) and causes the display image in question to be displayed on the display section 16 (S220).

Next, in the case where a parameter setting related to the image processing is changed, for example, by user operation input (YES in S224), the process returns to step S204, and the image processing and other processes are performed on the basis of a new parameter setting. On the other hand, if there is no user operation input, (NO in S224), the process is terminated.

It should be noted that the example illustrated in FIG. 19 is merely an example, and the operation according to the present embodiment can be diverse. For example, in the case where the input image is a video, the series of processes or some of the processes illustrated in FIG. 19 may be repeated. Also, although a decision as to whether the image processing is set to ON or OFF is made by one operation in the example illustrated in FIG. 19, a decision may be made as to whether each image processing task is ON or OFF. Also, the processes in step S214 (feature quantity identification) and in step S216 (effect level identification) may be performed prior to steps S214 and S216 as long as these processes are performed after steps S206, S208, and S210 in which the corresponding image processing tasks are performed.

### 2-3. Effect

A description has been given above of the second embodiment of the present disclosure. According to the second embodiment of the present disclosure, it is possible to display indicators regarding a plurality of image processing effects.

### 3. HARDWARE CONFIGURATION

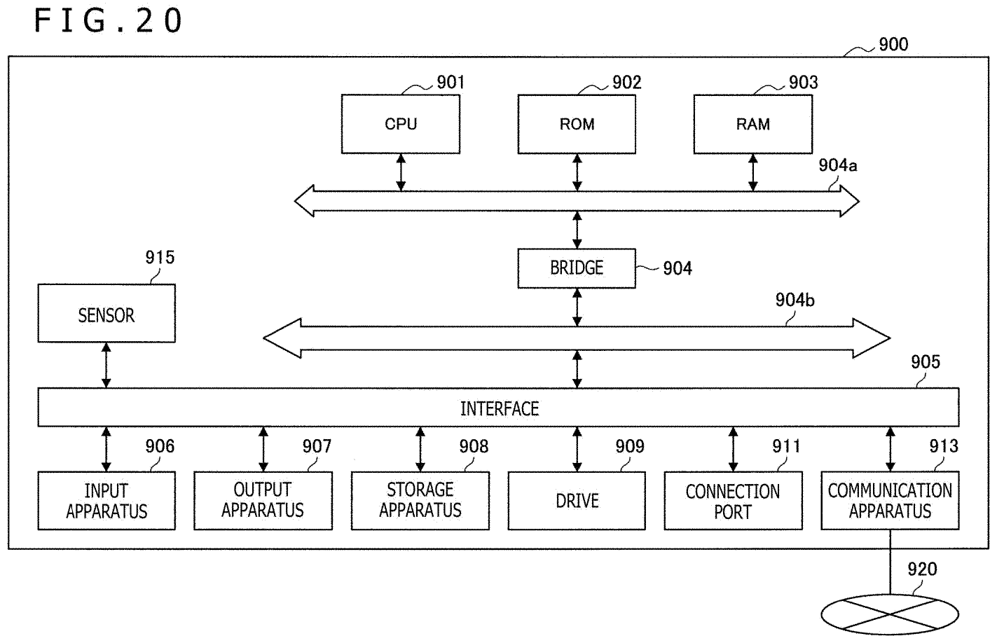

A description has been given above of embodiments of the present disclosure. Finally, a description will be given of a hardware configuration of an information processing apparatus according to the present embodiment with reference to FIG. 20. FIG. 20 is a block diagram illustrating an example of a hardware configuration of an information processing apparatus according to the present embodiment. It should be noted an information processing apparatus 900 illustrated in FIG. 20 can realize, for example, the information processing apparatus 1 and the information processing apparatus 1-2 illustrated in FIGS. 2 and 11, respectively. It should be noted that information processing performed by the information processing apparatus 1 and the information processing apparatus 1-2 according to the present embodiment is realized through coordination between software and hardware which will be described below.

As illustrated in FIG. 20, the information processing apparatus 900 includes a CPU (Central Processing Unit) 901, a ROM (Read Only Memory) 902, a RAM (Random Access Memory) 903, and a host bus 904a. The information processing apparatus 900 also includes a bridge 904, an external bus 904b, an interface 905, an input apparatus 906, an output apparatus 907, a storage apparatus 908, a drive 909, a connection port 911, a communication apparatus 913, and a sensor 915. The information processing apparatus 900 may have a processing circuit such as DSP or ASIC in place of, or together with, the CPU 901.

The CPU 901 functions as an arithmetic processing apparatus and a control apparatus and controls the operation as a whole within the information processing apparatus 900 in accordance with a variety of programs. Also, the CPU 901 may be a microprocessor. The ROM 902 stores programs, arithmetic parameters, and so on used by the CPU 901. The RAM 903 temporarily stores programs used by the CPU 901 for execution and parameters and other data that change as appropriate during execution of the programs. The CPU 901 can configure the control section 10 and the control section 10-2, for example.

The CPU 901, the ROM 902, and the RAM 903 are connected to each other by the host bus 904a that includes a CPU bus or the like. The host bus 904a is connected to the external bus 904b such as PCI (Peripheral Component Interconnect/Interface) bus via the bridge 904. It should be noted that the host bus 904a, the bridge 904, and the external bus 904b need not necessarily be separate from each other, and these functions may be implemented in a single bus.

The input apparatus 906 is realized, for example, by an apparatus through which information is input by the user such as a mouse, a keyboard, a touch panel, a button, a microphone, a switch, and a lever. Also, the input apparatus 906 may be, for example, a remote control apparatus using infrared rays or other radio waves. Alternatively, the input apparatus 906 may be external connection equipment such as a mobile phone or a PDA that supports the operation of the information processing apparatus 900. Further, the input apparatus 906 may include, for example, an input control circuit that generates an input signal on the basis of information input by the user by using the above input means and outputs the input signal to the CPU 901. The user of the information processing apparatus 900 can input a variety of pieces of data and issue instructions to the information processing apparatus 900 by operating this input apparatus 906. The input apparatus 906 can configure, for example, the operation acceptance section 14.

The output apparatus 907 includes an apparatus capable of visually or audibly notifying acquired information to the user. Among such apparatuses are a CRT display apparatus, a liquid crystal display apparatus, a plasma display apparatus, an EL display apparatus, and lamp and other display apparatuses, a sound output apparatus such as a speaker and headphones, and a printer apparatus. The output apparatus 907 outputs results acquired by a variety of processes performed by the information processing apparatus 900, for example. Specifically, the display apparatus visually displays results acquired by a variety of processes performed by the information processing apparatus 900 in various forms such as text, image, table, graph, and so on. On the other hand, the sound output apparatus converts an audio signal including reproduced audio data, acoustic data, and other data, into an analog signal and audibly outputs the analog signal. The output apparatus 907 can configure, for example, the display section 16.

The storage apparatus 908 is a data storage apparatus provided as an example of a storage section of the information processing apparatus 900. The storage apparatus 908 is realized, for example, by a magnetic storage device such as HDD, a semiconductor storage device, an optical storage device, or a magneto-optical storage device. The storage apparatus 908 may include a storage medium, a recording apparatus for recording data to the storage medium, a readout apparatus for reading out data from the storage medium, a deletion apparatus for deleting data recorded in the storage medium, and so on. This storage apparatus 908 stores programs to be executed by the CPU 901, a variety of pieces of data, a variety of pieces of data acquired from outside sources, and so on.

The drive 909 is a reader/writer for storage media and is built into or attached outside the information processing apparatus 900. The drive 909 reads out information recorded in a removable storage medium such as a magnetic disk, an optical disc, a magneto-optical disk, or a semiconductor memory to which the drive 909 is attached, outputting the information to the RAM 903. Also, the drive 909 can write information to the removable storage medium.

The connection port 911 is an interface connected to external equipment and is a connection port with external equipment capable of transporting data through USB (Universal Serial Bus), for example.

The communication apparatus 913 is a communication interface that includes a communication device for establishing connection with a network 920 and so on. The communication apparatus 913 is, for example, a communication card or other card for wired or wireless LAN (Local Area Network), LTE (Long Term Evolution), Bluetooth (registered trademark), or WUSB (Wireless USB). Also, the communication apparatus 913 may be a router for optical communication, a router for ADSL (Asymmetric Digital Subscriber Line), a modem for various types of communication, and the like. The communication apparatus 913 can, for example, exchange signals and so on with the Internet and other communication equipment, for example, in accordance with a given protocol such as TCP/IP.

The sensor 915 is, for example, one of a variety of sensors such as an acceleration sensor, a gyro sensor, a geomagnetic sensor, an optical sensor, a sound sensor, a distance measuring sensor, and a force sensor. The sensor 915 acquires information regarding statuses of the information processing apparatus 900 itself such as a posture and a traveling speed and information regarding a surrounding environment of the information processing apparatus 900 such as surrounding brightness and noise. Also, the sensor 915 may include a GPS sensor for receiving a GPS signal and measuring a longitude, latitude, and height of the information processing apparatus 900.

It should be noted that the network 920 is a wired or wireless transport channel through which information is sent from apparatuses connected to the network 920. For example, the network 920 may include public networks including the Internet, telephone networks, and satellite communication networks and a variety of LANs (Local Area Networks), WANs (Wide Area Networks), and so on including Ethernet (registered trademark). Also, the network 920 may include a leased line network such as IP-VPN (Internet Protocol-Virtual Private Network).

A description has been given above of a hardware configuration example that can realize the functions of the information processing apparatus 900 according to the present embodiment. Each of the above components may be realized by using general-purpose members or hardware specializing in the function of each component. Therefore, it is possible to change the hardware configuration to be used as appropriate according to the technological level at the time of carrying out the present embodiment.

It should be noted that a computer program for realizing each function of the information processing apparatus 900 according to the present embodiment can be created and implemented in a PC or other apparatus. Also, a computer-readable recording medium storing such a computer program can also be provided. The recording medium is, for example, a magnetic disk, an optical disc, a magneto-optical disk, or a flash memory. Also, the above computer program may be, for example, delivered via a network without using a recording medium.

### 4. CONCLUSION

As described above, according to embodiments of the present disclosure, it is possible to display an indicator regarding an effect of image processing actually performed.

Although preferred embodiments of the present disclosure have been described in detail above with reference to attached drawings, the technical scope of the present disclosure is not limited to such examples. It is apparent that a person having common knowledge in the technical field of the present disclosure can conceive of various modification or alteration examples without departing from technical ideas described in claims, and these modification or alteration examples are also naturally to be construed as belonging to the technical scope of the present disclosure.

Also, although, in the above embodiments, examples are described in which the information processing apparatuses according to the respective embodiments have a display function (display section), the present technology is not limited to such examples. For example, the present technology may be applied to an information processing apparatus connected to a display apparatus and having a display control section for controlling the display of the display apparatus. Also, an image processing apparatus that handles image processing and an information processing apparatus that handles processing such as feature quantity identification, effect level identification, display control and other processing described above may be separate. In such a case, the information processing apparatus may acquire images before and after image processing from the image processing apparatus and perform various processing tasks.

Also, the effects described in the present specification are merely descriptive or illustrative and are not restrictive. That is, the technology according to the present disclosure can produce an effect obvious to a person skilled in the art from the description in the present specification together with or in place of the above effects.

It should be noted that the configurations as described below also belong to the technical scope of the present disclosure:

(1) An information processing apparatus including:

a feature quantity identification section identifying, on the basis of an input image prior to image processing and an output image that has undergone the image processing, a feature quantity indicating a change made to an image by the image processing; and

a display control section causing an indicator regarding an effect of the image processing to be displayed on the basis of the feature quantity.

(2) The information processing apparatus of feature (1), further including:

an effect level identification section identifying an effect level indicating the effect of the image processing on the basis of the feature quantity, in which

the display control section causes the indicator to be displayed on the basis of the effect level identified on the basis of the feature quantity.

(3) The information processing apparatus of feature (2), in which

the effect level identification section identifies the effect level for an entire image, and

the display control section causes the indicator regarding the effect of the image processing for the entire image to be displayed.

(4) The information processing apparatus of feature (2), in which

the effect level identification section identifies the effect level for each pixel included in the image, and

the display control section causes, for each of the pixels, the indicator to be displayed with a pixel value appropriate to the effect level.

(5) The information processing apparatus of any one of features (2) to (4), in which

the display control section causes the indicator and the output image to be displayed at the same time.

(6) The information processing apparatus of feature (5), in which

the display control section causes the indicator to be superimposed on the output image for display.

(7) The information processing apparatus of feature (5), in which

the display control section causes color information appropriate to the effect level to be displayed as the indicator.

(8) The information processing apparatus of feature (7), in which

the display control section causes a display image in which color information of the output image has been replaced with color information appropriate to the effect level to be displayed.

(9) The information processing apparatus of feature (7), in which

the display control section causes a display image acquired by adding color information appropriate to the effect level to color information of the output image to be displayed.

(10) The information processing apparatus of feature (5), in which

the display control section causes the indicator indicating a region where the image processing is significantly effective in the output image to be displayed.

(11) The information processing apparatus of feature (10), in which

the display control section causes a plurality of gradual borders appropriate to heights of the effect levels in the output image to be displayed as the indicator.

(12) The information processing apparatus of any one of features (5) to (11), in which

the display control section causes a child screen with the indicator in a reduced size to be superimposed on the output image for display.

(13) The information processing apparatus of any one of features (1) to (12), in which

the display control section causes an indicator regarding effects of a plurality of image processing tasks to be displayed.

(14) The information processing apparatus of feature (13), in which

the display control section causes the indicator and an output image that has been subjected to all the plurality of image processing tasks to be displayed at the same time.

(15) The information processing apparatus of feature (13) or (14), in which

the display control section causes the indicator having a plurality of axes corresponding to the plurality of effect levels to be displayed.

(16) The information processing apparatus of feature (13) or (14), in which

the display control section causes a first child screen with the indicator reduced in size and a second child screen depicting flows of the plurality of image processing tasks to be displayed.

(17) The information processing apparatus of feature (16), in which

the display control section causes a display of the first child screen to be changed appropriately to a user operation.

(18) The information processing apparatus of any one of features (1) to (17), further including:

an image processing section performing the image processing appropriately to a user operation.

(19) The information processing apparatus of feature (18), in which

the image processing is performed on the basis of a parameter set appropriately to the user operation.

(20) An information processing method including:

identifying, on the basis of an input image prior to image processing and an output image that has undergone the image processing, a feature quantity indicating a change made to an image by the image processing; and

causing an indicator regarding an effect of the image processing to be displayed on the basis of the feature quantity.

### REFERENCE SIGNS LIST

1: Information processing apparatus
10: Control section
12: Image input section
14: Operation acceptance section
16: Display section
120 to 123: Image processing section
140 to 143: Feature quantity identification section
160 to 163: Effect level identification section
180, 182: Display control section

1. An information processing apparatus comprising:
a feature quantity identification section identifying, on a basis of an input image prior to image processing and an output image that has undergone the image processing, a feature quantity indicating a change made to an image by the image processing; and
a display control section causing an indicator regarding an effect of the image processing to be displayed on a basis of the feature quantity.

2. The information processing apparatus of claim 1, further comprising:
an effect level identification section identifying an effect level indicating the effect of the image processing on the basis of the feature quantity, wherein
the display control section causes the indicator to be displayed on a basis of the effect level identified on the basis of the feature quantity.

3. The information processing apparatus of claim 2, wherein
the effect level identification section identifies the effect level for an entire image, and
the display control section causes the indicator regarding the effect of the image processing for the entire image to be displayed.

4. The information processing apparatus of claim 2, wherein
the effect level identification section identifies the effect level for each pixel included in the image, and the display control section causes, for each of the pixels, the indicator to be displayed with a pixel value appropriate to the effect level.

5. The information processing apparatus of claim 2, wherein
the display control section causes the indicator and the output image to be displayed at a same time.

6. The information processing apparatus of claim 5, wherein
the display control section causes the indicator to be superimposed on the output image for display.

7. The information processing apparatus of claim 5, wherein
the display control section causes color information appropriate to the effect level to be displayed as the indicator.

8. The information processing apparatus of claim 7, wherein
the display control section causes a display image in which color information of the output image has been replaced with color information appropriate to the effect level to be displayed.

9. The information processing apparatus of claim 7, wherein
the display control section causes a display image acquired by adding color information appropriate to the effect level to color information of the output image to be displayed.

10. The information processing apparatus of claim 5, wherein
the display control section causes the indicator indicating a region where the image processing is significantly effective in the output image to be displayed.

11. The information processing apparatus of claim 10, wherein
the display control section causes a plurality of gradual borders appropriate to heights of the effect levels in the output image to be displayed as the indicator.

12. The information processing apparatus of claim 5, wherein
the display control section causes a child screen with the indicator in a reduced size to be superimposed on the output image for display.

13. The information processing apparatus of claim 1, wherein
the display control section causes an indicator regarding effects of a plurality of image processing tasks to be displayed.

14. The information processing apparatus of claim 13, wherein
the display control section causes the indicator and an output image that has been subjected to all the plurality of image processing tasks to be displayed at a same time.

15. The information processing apparatus of claim 13, wherein
the display control section causes the indicator having a plurality of axes corresponding to the plurality of effect levels to be displayed.

16. The information processing apparatus of claim 13, wherein
the display control section causes a first child screen with the indicator reduced in size and a second child screen depicting flows of the plurality of image processing tasks to be displayed.

17. The information processing apparatus of claim 16, wherein
the display control section causes a display of the first child screen to be changed appropriately to a user operation.

18. The information processing apparatus of claim 1, further comprising:
an image processing section performing the image processing appropriately to a user operation.

19. The information processing apparatus of claim 18, wherein
the image processing is performed on a basis of a parameter set appropriately to the user operation.

20. An information processing method comprising:
identifying, on a basis of an input image prior to image processing and an output image that has undergone the image processing, a feature quantity indicating a change made to an image by the image processing; and
causing an indicator regarding an effect of the image processing to be displayed on a basis of the feature quantity.
